(19) United States
(12) Patent Application Publication
(10) Pub. No.: US 2018/0058404 A1
(43) Pub. Date: Mar. 1, 2018

(54) FUEL INJECTOR ASSEMBLY WITH WIRE MESH DAMPER

(71) Applicant: Parker-Hannifin Corporation, Cleveland, OH (US)

(72) Inventor: David Tibbs, Summerville, SC (US)

(21) Appl. No.: 15/684,274

(22) Filed: Aug. 23, 2017

Related U.S. Application Data
(60) Provisional application No. 62/380,507, filed on Aug. 29, 2016.

(51) Int. Cl. F02M 55/04; F02M 55/00; F02M 61/16

(52) U.S. Cl. CPC F02M 55/04; F02M 2200/03; F02M 61/167; F02M 55/008

(57) ABSTRACT

A gas turbine fuel injector assembly including one or more dampers for damping vibration of one or more fuel conduits in the assembly. The dampers may at least partially surround the fuel conduits, and each damper has an intermediate portion that is bowed relative to axial end portions to form a pocket, which enables the damper to be free to flex radially for damping vibration experienced by the fuel conduit during operation. The damper may be a wire mesh damper formed with interwoven wires that are configured to move relative to each other in response to vibrational movement of the fuel conduit. The wire mesh damper also may enable fluids, such as gases or fuel, to flow through gaps in the wire mesh. The damper may support and damp individual fuel conduits, thereby enabling the fuel conduits to thermally expand independently of each other in the assembly.

### RELATED APPLICATIONS

This application claims the benefit of U.S. Provisional Application No. 62/380,507 filed Aug. 29, 2016, which is hereby incorporated herein by reference in its entirety.

### FIELD OF INVENTION

The present invention relates generally to fuel injectors, and more particularly to vibration dampers for fuel injectors, such as for use with gas turbine combustion engines.

### BACKGROUND

A gas turbine engine contains a compressor in fluid communication with a combustion system that often contains a plurality of combustors. The compressor raises the pressure of the air passing through each stage of the compressor and directs it to the combustors where fuel is injected and mixed with the compressed air. The fuel and air mixture ignites and combusts creating a flow of hot gases that are then directed into the turbine. The hot gases drive the turbine, which in turn drives the compressor, and for electrical generation purposes, can also drive a generator.

Most combustion systems utilize a plurality of fuel injectors for staging, emissions purposes, and flame stability. Fuel injectors for applications such as gas turbine combustion engines direct pressurized fuel from a manifold to the one or more combustion chambers. Fuel injectors also function to prepare the fuel for mixing with air prior to combustion. Each fuel injector typically has an inlet fitting connected either directly or via tubing to the manifold, a tubular extension or stem connected at one end to the fitting, and one or more spray nozzles connected to the other end of the stem for directing the fuel into the combustion chamber. A fuel passage (e.g., a tube or cylindrical passage) extends through the stem to supply the fuel from the inlet fitting to the nozzle. Appropriate valves and/or flow dividers can be provided to direct and control the flow of fuel through the nozzle and/or fuel passage.

Of some concern in the design of any component of a gas turbine engine, and in particular the fuel feed conduit, is high cycle fatigue. High cycle fatigue generally occurs when resonance or vibration modes are excited by driving frequencies inherent in the operation of the engine. For example, shaft rotation imbalance can produce driving frequencies between about 50 to about 300 Hertz (Hz). Driving frequencies due to combustion rumble can be in the range of about 300 Hz to about 800 Hz. Fuel pump pulsations can produce driving frequencies in the range of 1200 Hz. Blade passing frequencies can be upwards of 1200 Hz. In the event vibration occurs, such as a resonant driving frequency, the fuel feed conduit can be damaged.

### SUMMARY OF INVENTION

The present invention provides a damper for a fuel injector assembly that is configured to damp vibration and dissipate energy of one or more fuel conduits in the assembly. Such a damper may be configured to at least partially surround at least one fuel conduit, and may have an intermediate portion that is bowed relative to axial end portions to form a pocket, which enables the damper to be free to flex radially in response to vibrational movement experienced by the fuel conduit(s) during operation of the fuel injector assembly.

More particularly, the damper may be a wire mesh damper formed with interwoven wires that are arranged in a predetermined pattern. The interwoven wires may be configured to cross-over each other and move relative to each other in response to movement of the at least one fuel conduit, thereby enabling the intermediate portion of the damper to freely flex radially for damping vibration of the at least one fuel conduit. The wire mesh damper also may enable fluids, such as gases or fuel, to flow through the gaps provided by the wire mesh. In some embodiments, the escape of hot gases through the damper may enable a more uniform temperature distribution along the length of the fuel conduit. In other embodiments, the ability to flow fuel through the damper allows the damper to be utilized in an annular-shaped fuel conduit.

The damper also may enable the at least one fuel conduit to freely expand axially in response to thermal expansion of the fuel injector assembly and thereby reduce undesirable stresses in the assembly. More particularly, the damper may surround and support individual fuel conduits within the fuel injector assembly, thereby enabling individual fuel conduits to independently expand axially relative to each other.

The damper may be relatively easy to manufacture and install in the fuel injector assembly, and can provide adequate damping to dissipate energy from the assembly, thereby preventing fuel conduit damage at minimal cost.

According to one aspect of the present disclosure, a gas turbine fuel injector assembly includes: a stem housing having one end configured for mounting in a gas turbine engine, and an opposite end for supporting a nozzle; at least one fuel conduit extending through the stem housing for directing fuel to the nozzle; and at least one wire mesh damper configured to at least partially surround the at least one fuel conduit within the stem housing, the at least one wire mesh damper having opposite axial end portions and an intermediate portion between the axial end portions; wherein the intermediate portion is bowed relative to the axial end portions to form a pocket intermediate the axial end portions, the bowed intermediate portion enabling the wire mesh damper to be free to flex radially in response to movement of the at least one fuel conduit for damping vibration of the at least one fuel conduit.

According to another aspect of the present disclosure, a damper for supporting and damping vibration of a tube in a gas turbine fuel injector assembly includes: a tubular body extending along a longitudinal axis, the tubular body having opposite axial end portions and an intermediate portion between the opposite end portions; wherein the intermediate portion is radially offset from the axial end portions to form a pocket intermediate the opposite axial end portions.

According to another aspect of the present disclosure, a wire mesh damper for supporting and damping vibration of a tube in a gas turbine fuel injector assembly includes: a tubular body extending along a longitudinal axis, the tubular body having opposite axial end portions and a central portion between the opposite end portions; wherein the central portion of the tubular body has a radial inner diameter that is greater than a radial inner diameter of the respective end portions such that the radial inner diameter of the central portion forms an interior pocket between the opposite end portions of the tubular body.

According to another aspect of the present disclosure, a damper for supporting and damping vibration of a tube in a gas turbine fuel injector assembly includes: a body extending along a longitudinal axis, the body having a first portion and a longitudinally adjacent second portion; wherein the second portion is offset radially outwardly relative to the first portion to form a pocket radially inwardly of the second portion. In some embodiments, the first portion may be a first axial end portion of the damper body that forms a neck, and the second portion may be a second axial end portion of the damper body that forms a bulge, such that the pocket radially inwardly of the bulge opens in the longitudinal direction.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 is a perspective view of the inlet into a combustion chamber for a gas turbine engine including an exemplary fuel injector assembly according to an embodiment of the disclosure.

FIG. 2 is a cross-sectional side view of the fuel injector assembly in FIG. 1, including exemplary dampers according to an embodiment of the disclosure.

FIG. 3 is an enlarged cross-sectional side view showing the dampers along a portion of the fuel injector assembly taken about the portion 3-3 in FIG. 2.

FIG. 4A is a side view of an exemplary wire mesh damper installed on a fuel conduit according to an embodiment of the disclosure. FIG. 4B is an enlarged view of an end portion of the wire mesh damper in FIG. 4A. FIG. 4C is an enlarged view of an intermediate portion of the wire mesh damper in FIG. 4A.

FIG. 5 is a cross-sectional side view of another exemplary damper for a fuel injector assembly in accordance with an embodiment of the disclosure.

FIG. 6 is a cross-sectional side view of another exemplary damper for a fuel injector assembly in accordance with an embodiment of the disclosure.

FIG. 7 is a cross-sectional side view of another exemplary fuel injector assembly having dampers according to an embodiment of the disclosure.

FIG. 8 is a cross-sectional side view of another exemplary fuel injector assembly having dampers according to an embodiment of the disclosure.

### DETAILED DESCRIPTION

The principles of the present invention have particular application for fuel injector assemblies used in gas turbine combustion engines, such as for aircraft, and thus will be described below chiefly in this context. It is also understood that principles of this invention may be applicable to other parts and components of gas turbine engines, as well as other machinery, where parts and components are subject to vibration and high-cycle fatigue, and where it is desirable to provide an improved damper that damps such vibration and dissipates energy of such parts and components.

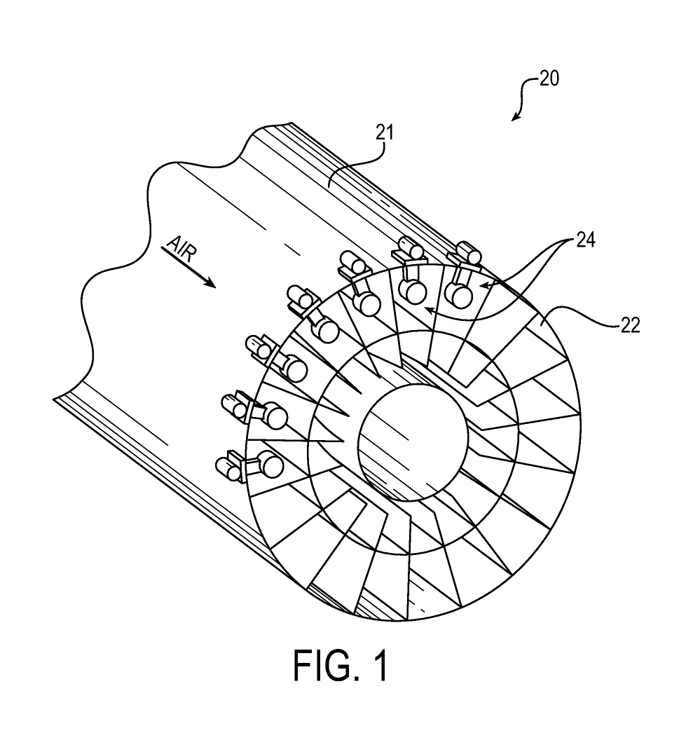

Referring to the drawings and initially to FIG. 1, a portion of a combustion engine 20 is shown having an outer casing 21, an upstream front wall of a dual combustion chamber 22, and a plurality of fuel injector assemblies 24, or fuel injectors, supported within the combustion chamber. The fuel injector assemblies 24 may be received within respective apertures formed in the engine casing and extend inwardly into the combustor chamber 22. The fuel injector assemblies 24 atomize and direct fuel into the combustion chamber 22 for burning. The combustion chamber 22 can be any useful type of combustion chamber, such as a combustion chamber for a gas turbine combustion engine of an aircraft where temperatures may reach up to 1300° F. It is understood, however, that the principles of the present invention may be useful for combustion chambers of any type of combustion application, such as in stationary or in land vehicles.

As illustrated in FIG. 1, a single nozzle arrangement for each injector is shown, where each of the fuel injector assemblies 24 includes a single nozzle assembly for directing fuel into the combustion chamber 22. It should be noted that this single nozzle arrangement is only provided for exemplary purposes, and the present invention may be useful with a dual nozzle assembly where each of the fuel injector assemblies 24 includes two nozzle assemblies for directing fuel into radially inner and outer zones of the combustion chamber 22. Fuel injectors having more than two nozzle assemblies in a concentric or series configuration may also be used. It should also be noted that while a number of such injectors are shown in an evenly-spaced annular arrangement, the number and location of such injectors can vary, depending upon the particular application.

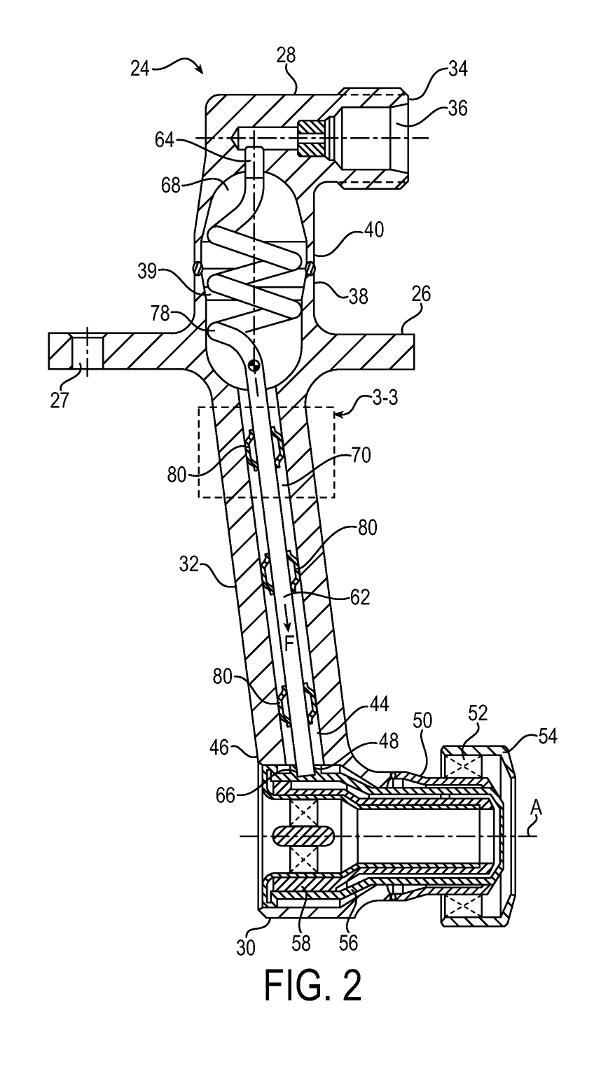

Referring now to FIG. 2, each of the fuel injector assemblies 24, which are typically identical, includes a nozzle mount or flange 26 adapted to be fixed and sealed to the wall of the combustor casing 21, such as with appropriate fasteners. The fuel injector assembly 24 also includes a fitting 28 disposed exterior of the engine casing for receiving fuel, a fuel nozzle 30 disposed within the combustor for dispensing fuel, and a housing stem 32 interconnecting and structurally supporting nozzle 30 with respect to fitting 28.

The fitting 28 for the fuel injector may include an inlet assembly 34 that may be integral with or fixed to flange 26 such as by brazing or welding. The inlet assembly 34 may have an inlet opening 36, which may receive a corresponding conduit (not shown) to fluidly connect the fuel manifold of the engine to direct fuel into the fuel injector 24. The inlet assembly 34 is preferably formed from material appropriate for the particular application, for example, appropriate heat-resistant and corrosion-resistant material, such as Hastelloy X metal.

The housing stem 32 may be integral or fixed to the flange 26 (such as by brazing or welding). The flange 26 may include apertures 27 extending therethrough to allow the flange to be easily and securely connected to, and disconnected from, the outer casing 21 of the engine using, e.g., bolts or rivets. The housing stem 32 may include an inlet end 38 with annular inlet opening 39. The inlet end 36 may be attached to an outlet end 40 of fitting 28 in a conventional manner, such as by welding, to provide a fluid-tight seal. The housing stem 32 may be generally cylindrical and may include an inner chamber that extends from the inlet end 38 of the housing stem 32 to an outlet opening 44 at the outlet end 46 of the housing stem. The housing stem 32 may have a radial thickness sufficient to support the nozzle 30 in the combustor when the injector is mounted to the engine, and may be formed from appropriate heat-resistant and corrosion resistant material, such as Hastelloy X.

The lower end 46 of housing stem 32 may be formed integrally with fuel nozzle 30, and preferably in one piece with at least a portion of the nozzle 30. For example, the outlet end 46 of the housing stem may include an annular outer shroud 48 circumscribing the longitudinal axis “A” of the nozzle 30. The outer shroud 48 may be connected at its downstream end to an outer air swirler 50, such as by welding. The outer air swirler 50 may include radially-outward projecting swirler vanes 52 and an outer annular shroud 54. An inner annular prefilmer 56 and an annular fuel swirler 58 may be disposed radially inwardly from the outer shroud 48, and together may define an annular fuel passage through the nozzle 30. The prefilmer 56 may have a fuel inlet opening at its upstream end. Although only a single nozzle 30 is shown, the exemplary fuel injector 24 may have two or more nozzles. For example, the fuel injector 24 could include a pilot nozzle and a secondary nozzle, where both nozzles may be used during normal or extreme power situations, while only the pilot nozzle is generally used during start-up. It is understood that while an exemplary embodiment of the nozzle 30 is shown, other nozzle designs may be used as understood by those having ordinary skill in the art.

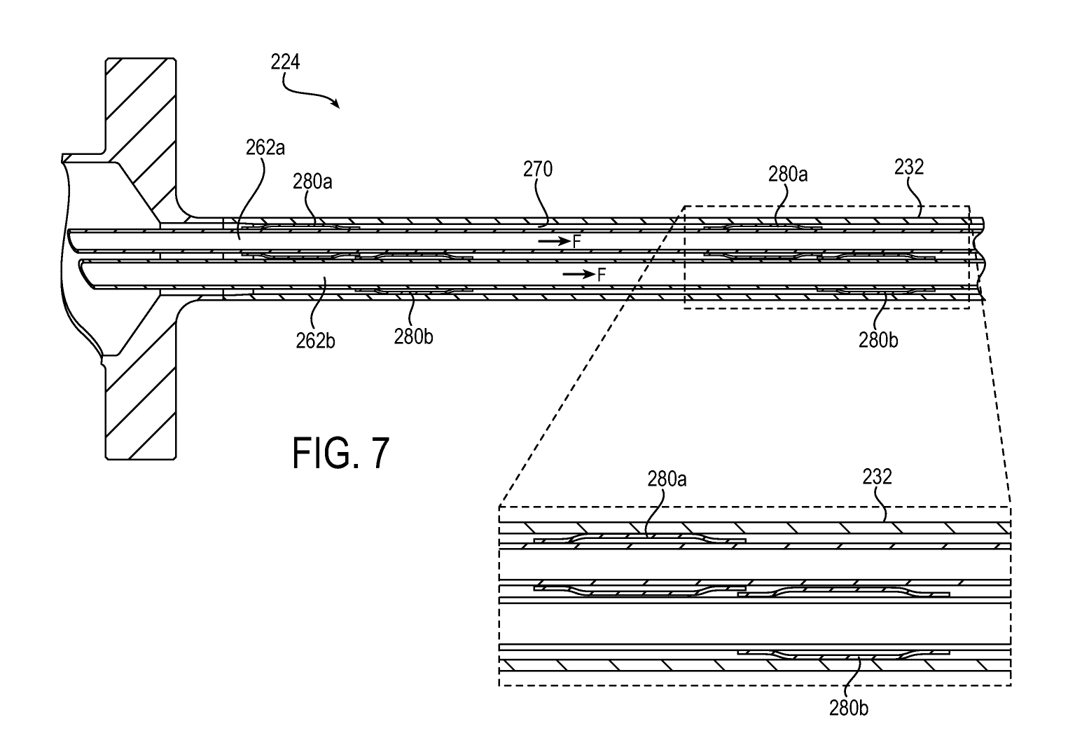

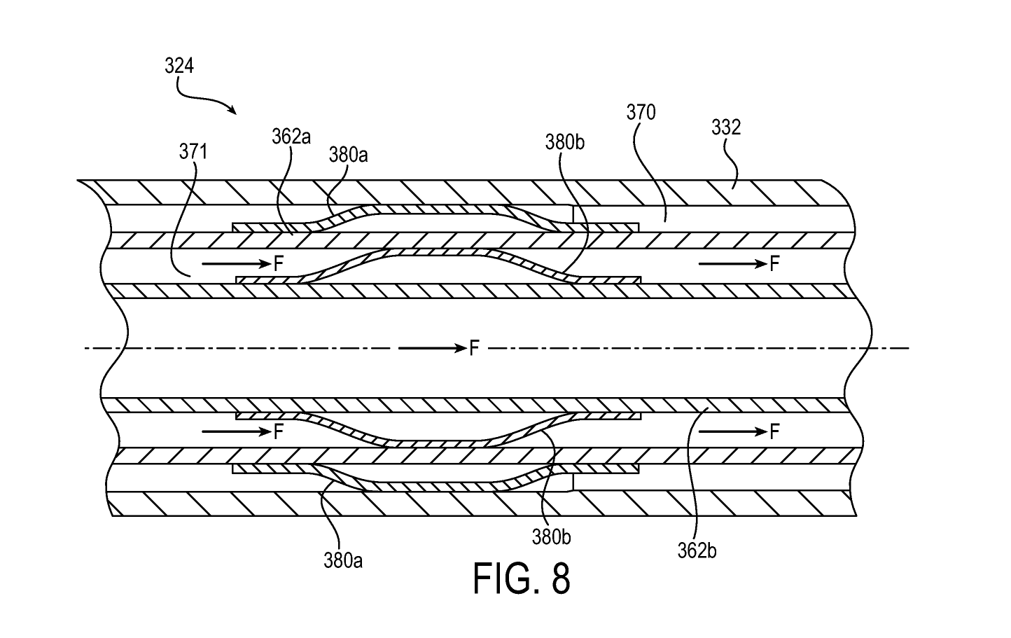

One or more fuel conduits 62 are provided to fluidly interconnect the fitting 28 with the nozzle 30. Each of the fuel conduits 62 may extend from a first connection end 64 tightly received within a passage of the fitting 28, to a second connection end 66 tightly received within a passage in the prefilmer 56. The ends of the fuel conduits 62 can be fluidly sealed and rigidly and permanently attached within the respective passages in an appropriate manner, for example, welding or brazing. As shown in the illustrated embodiment, only a single fuel flow conduit 62 is provided from the inlet to the nozzle, which has a rigid fluid-tight connection at an upper end with the inlet fitting to receive fuel from one or more fuel inlet passages in the fitting, and a rigid, fluid-tight connection at the lower end with the nozzle to convey the fuel (F) to fuel discharge passages in the nozzle. It is understood, however, that the fuel injector assembly 24 may include more than one fuel flow conduit or passage from the fuel inlet to the nozzle (as shown in FIGS. 7 and 8, for example). In addition, the fuel conduit(s) 62 may be cylindrical as shown, however, other configurations may be used, such as fuel feed strips having an elongated, essentially flat shape in cross-section. The fuel conduit(s) 62 may be formed from appropriate heat-resistant and corrosion-resistant material, for example 300-series stainless steel.

As shown in the illustrated embodiment, the fuel conduit 62 extends within an upper chamber 68 defined by the fitting 28 and/or upper inlet end 38 of housing stem, through a lower chamber 70 defined by the housing stem 32, and into opening 44. To allow the fuel conduit 62 to thermally expand and contract within the fuel injector, the fuel conduit 62 may include a coiled or convoluted portion 78 toward the upstream end of the conduit 62. The coiled portion 78 may be received within the upper chamber 68. The coiled portion 78 of the fuel conduit can be formed in any conventional manner, such as by bending the fuel conduit around a mandrel.

As shown in the illustrated embodiment, the fuel conduit 62 may be closely surrounded by the internal surface of the housing stem 32 such that a small gap separates the exterior surface of the fuel conduit 62 and the internal surface of the chamber. The gap should be small enough to minimize the overall size of the fuel conduit, yet large enough such that stagnant air in the gap provides appropriate thermal protection for the fuel in the fuel conduit. The size of the gap can vary depending upon the particular application, and may be provided along substantially the entire length of the fluid conduit 62, except where the fuel conduit connects to the inlet fitting and to the fuel nozzle. As shown, one fuel conduit 62 extends along the length of the chamber 70.

During operation, the exemplary fuel injector assembly 24 may experience vibration due to driving frequencies inherent in the operation of the engine, and such vibration may cause damage to the at least one fuel conduit 62. To damp such vibration and prevent damage to the conduit 62, one or more dampers 80 are provided in the exemplary fuel injector 24, as explained in further detail below. As shown, multiple dampers 80 may be located along the axial length of the conduit 62.

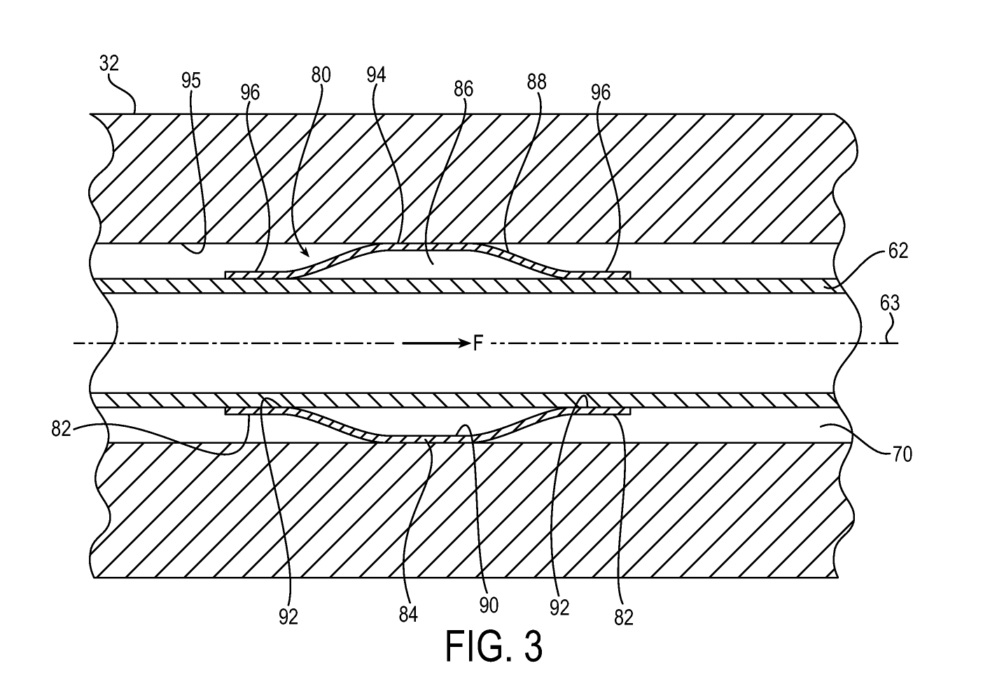

Referring to FIG. 3, an enlarged cross-sectional view of a portion of fuel injector assembly 24 having the dampers 80 is shown in further detail. As shown, each damper 80 is configured to at least partially surround the at least one fuel conduit 62 within the stem housing 32. The damper 80 has opposite axial end portions 82 and an intermediate portion 84 between the axial end portions, wherein the intermediate portion is bowed or radially offset relative to the axial end portions 82 to form a pocket 86 intermediate the axial end portions. In this manner, the bowed intermediate portion enables the damper 80 to be free to flex radially in response to movement of the at least one fuel conduit 62 so as to damp vibration of the at least one fuel conduit.

In the exemplary embodiment, the intermediate portion 84 is bowed radially outwardly with respect to the axial end portions 82 to form the pocket 86 at a radially interior portion of the damper 80, such that a bulge 88 forms at a radially exterior portion that is opposite the pocket 86. In the illustrated embodiment, the fuel conduit 62 is cylindrical and the damper 80 has a tubular body configured such that the radially inner diameter of intermediate portion 84 is greater than a radially inner diameter of the axial end portions 82 to form the radial interior pocket 86. In addition, the radially outer diameter of the intermediate portion 84 is greater than the outer diameter of the axial end portions 82 to define at least a portion of the radial bulge 88.

As shown, a radially inner intermediate surface 90 and radially inner end surfaces 92 surround the at least one fuel conduit 62 about a longitudinal axis 63 thereof. The radially inner intermediate surface 90 is spaced apart from the at least one fuel conduit 62 to form the pocket 86, and the radially inner end surfaces 92 are configured to engage the at least one fuel conduit 62. A radially outer intermediate surface 94 forming at least a portion of the bulge 88 is configured to engage an internal surface 95 of the stem housing 32, and radially outer end surfaces 96 are spaced apart from inner surface 95 of the stem housing 32. In this manner, at least one of the axial end portions 82 may be fixed to the at least one fuel conduit 62, such as by brazing, welding, or other suitable form of attachment. On the other hand, the radially outwardly bulged intermediate portion 84 is preferably free from attachment to the internal surface 95 of the stem housing, which allows the fuel conduit 62 to freely expand axially in response to thermal expansion of the fuel injector assembly and thereby reduce undesirable stresses in the assembly.

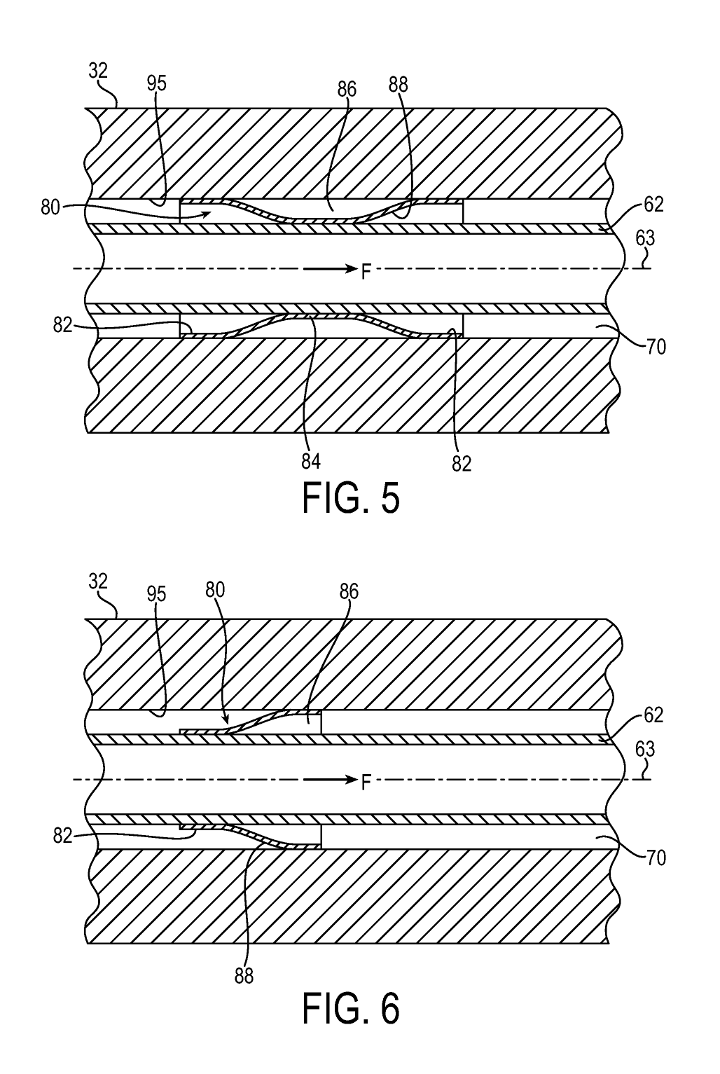

By providing the pocket 86 at a radially inner portion and the bulge 88 at a radially outer portion, the intermediate portion 84 may provide support for the fuel conduit 62 by engaging the inner surface 95 defining the chamber 70, while also damping vibration by enabling the intermediate bowed portion 84 to be free to flex. In exemplary embodiments, the damper 80 has only a single radial pocket 86 at the intermediate portion 84 between the axial end portions 82. The damper 80 may have a uniform wall thickness, or the wall thickness may vary to accommodate for more rigidity or flexibility of certain portions as desired. It is understood that although the exemplary damper 80 is shown having a radially interior pocket 86, in some embodiments the intermediate portion 84 may be bowed radially inwardly such that the pocket is formed at a radially outer portion so that the axial ends 82 are free to flex (as shown in FIG. 5, for example). Alternatively, the intermediate portion 84 forming the bulge may be one axial end portion longitudinally adjacent to another narrower axial end portion 82, such that the pocket 86 opens into the gap containing the damper (as shown in FIG. 6, for example).

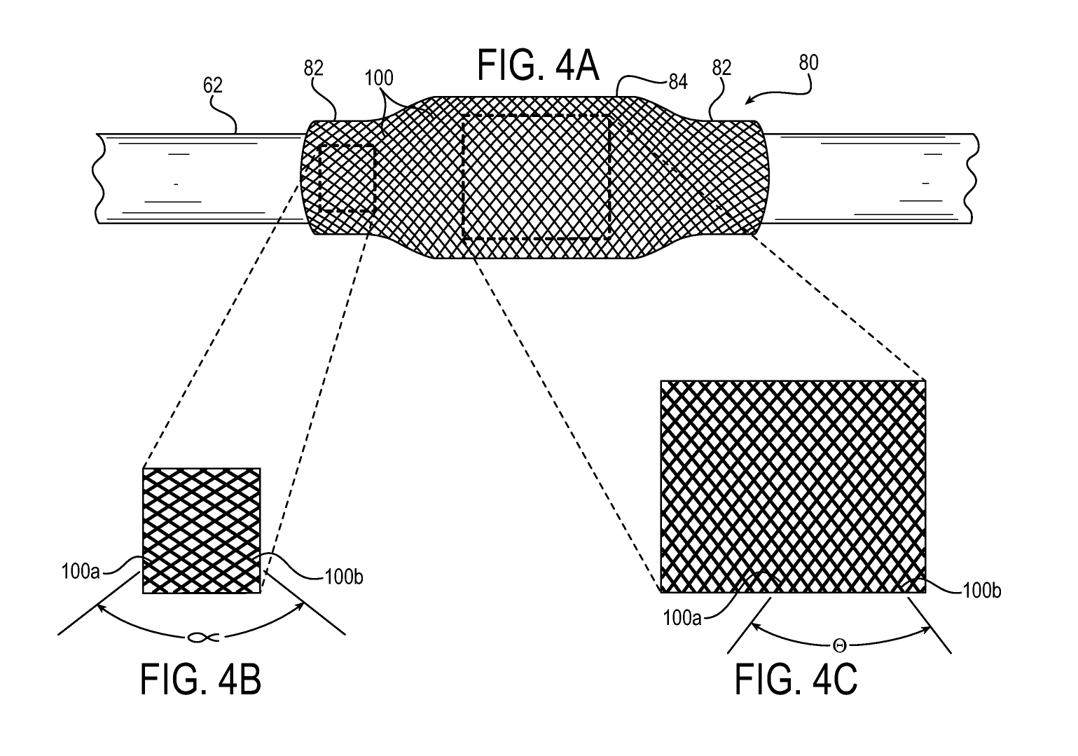

In exemplary embodiments, the damper 80 is configured as a wire mesh damper, such as a wire mesh sleeve formed from interwoven wires 100, as shown in FIGS. 4A-4C. As shown, the interwoven wires 100 (e.g., 100a and 100b) cross over each other to define respective included angles (α, θ) therebetween. The respective included angles (θ) between the interwoven wires (e.g., 100a, 100b) that form the radially outwardly bowed intermediate portion 84 (shown in FIG. 4C) have an angle that is fewer degrees than the respective included angles (a) between the interwoven wires (e.g., 100a, 100b) that form the axial end portions 82 (shown in FIG. 4B). In exemplary embodiments, the interwoven wires 100 forming the intermediate portion 84 are configured to move relative to each other to vary the included angle therebetween in response to movement of the at least one fuel conduit 62, which enables the intermediate portion 84 to freely flex radially for damping vibration of the at least one fuel conduit 62. The interwoven loops of the wire mesh damper may move relative to each other without permanently deforming the wire mesh damper 80, which provides the damper 80 with a resiliency that enables a spring-like function. In the illustrated embodiment, the wires 100 are interwoven to cross over each other in a diamond-shaped pattern, similar to a cross-link fence arrangement.

In exemplary embodiments, the wires 100 of the damper 80 are made from steel, stainless steel, nickel-based alloys (such as Inconel or Hastelloy), or similar high-temperature metals. In addition, the wires should be made with a material that is compatible with the fuel conduits and should have good fatigue strength, especially at high temperatures. In exemplary embodiments, the wire mesh damper has a wire density of between about 40×40 wires per inch to about 100×100 wires per inch, preferably about 60×60 wires per inch. In exemplary embodiments, the wire diameter is between about 0.005 inches to about 0.050 inches. Generally, the wire mesh should have sufficient rigidity to maintain the shape of the bowed portion, but should also be flexible enough to be free to flex so as to damp vibration.

Turning to FIG. 5, another exemplary embodiment of the damper 80 is shown in which the intermediate portion 84 is bowed radially inwardly relative to the axial end portions 82, such that the pocket 86 is formed radially outwardly of the intermediate portion 84, and the axial ends 82 are free to flex. It is understood that the damper 80 in FIG. 5 is similar to the damper 80 in FIG. 3 or FIG. 4, and consequently the same reference numerals are used to denote structures corresponding to similar structures. Likewise, the foregoing description of FIGS. 2-4 is equally applicable to the exemplary damper 80 in FIG. 5.

Turning to FIG. 6, another exemplary embodiment of the damper 80 is shown in which a first portion of the damper body is a first axial end portion 82 that forms a neck, and a second portion of the damper body that is longitudinally adjacent to the first portion forms the bulge 88, such that the bulge 88 is at the second axial end of the damper body, and the pocket 86 radially inwardly of the bulge 88 opens in the longitudinal direction to the gap (chamber 70) containing the damper 80. It is understood that the damper 80 in FIG. 6 is similar to the damper 80 in FIGS. 3-5, and consequently the same reference numerals are used to denote structures corresponding to similar structures. Likewise, the foregoing description of FIGS. 2-5 is equally applicable to the exemplary damper 80 in FIG. 6.

Turning to FIG. 7, another exemplary embodiment of a fuel injector assembly 224 is shown. The fuel injector assembly 224 is substantially similar to the above-referenced fuel injector assembly 24, except that two fuel conduits 262a and 262b are disposed within internal chamber 270 of stem housing 232. Consequently, the same reference numerals but indexed by 200 are used to denote structures corresponding to similar structures in the fuel injector assemblies 24, 224. In addition, the foregoing description of the fuel injector assembly 24 is equally applicable to the fuel injector assembly 224, as would be understood by those having ordinary skill in the art, and thus aspects of the fuel injector assemblies 24, 224 may be substituted for one another or used in conjunction with one another where applicable.

As shown in the illustrated embodiment, the two fuel conduits 262a and 262b extend along the length of chamber 270, and are each configured to convey fuel (F) to one or more nozzles (not shown). The fuel conduits 262a, 262b may be evenly spaced apart from each other along the length of the stem housing 232 such that they ideally do not contact each other or contact the internal wall of the stem housing 232. Each conduit 262a and 262b includes one or more dampers 280, which may be the same as or substantially similar to the above-described damper 80, and which may be configured on the fuel conduits 262a, 262b in the same manner as described above. In the illustrated embodiment, the first fuel conduit 262a includes at least one first wire mesh damper 280a, and the second fuel conduit 262b includes at least one second wire mesh damper 280b. The first damper 280a and the second damper 280b are each configured to support and damp vibrations of the first and second fuel conduits by occupying the void space around each of the first and second fuel conduits in a radial direction across the stem housing 232. In addition, the dampers 280a, 280b also may enable the fuel conduits 262a, 262b to freely expand axially relative to each other in response to thermal expansion of the fuel injector assembly, thereby reducing undesirable stresses in the assembly.

In exemplary embodiments, the first damper 280a and the second damper 280b are fixed to the respective first and second fuel conduits in a longitudinally offset arrangement. In this manner, a first portion of an outer surface forming the bulge of the first damper 280a engages a first portion of an inner surface of the stem housing 232, and a second portion of the outer surface of the first damper 280a engages an outer portion of the adjacent second fuel conduit 262b; and vice versa for the second damper 280b on the second fuel conduit 262b. Such an offset arrangement may allow the wire mesh dampers 280a, 280b to damp vibrations and prevent contact between the fuel conduits 262a, 262b while also minimizing space. The offset arrangement of the dampers 280a, 280b may be provided in an axially overlapping configuration, as shown, or the dampers may be non-overlapping. It is also understood that the dampers 280a, 280b could be axially aligned with each other so as to contact each other if desired.

Turning to FIG. 8, another exemplary embodiment of a fuel injector assembly 324 is shown. The fuel injector assembly 324 is substantially similar to the above-referenced fuel injector assembly 224, except that the second fuel conduit 362b is disposed radially inwardly of the first fuel conduit 362a to form an annular fuel passage 371 therebetween. Consequently, the same reference numerals but indexed with the prefix ‘3’ are used to denote structures corresponding to similar structures in the fuel injector assemblies 24, 224, 324. In addition, the foregoing description of the fuel injector assemblies 24, 224 is equally applicable to the fuel injector assembly 324, as would be understood by those having ordinary skill in the art, and thus aspects of the fuel injector assemblies 24, 224, 324 may be substituted for one another or used in conjunction with one another where applicable.

In the illustrated embodiment, the two fuel conduits 362a and 362b extend along the length of internal chamber 370 within the stem housing 332, and are each configured to convey fuel (F), such as liquid or gaseous fuel, to one or more nozzles (not shown). The second fuel conduit 362b is provided radially inwardly in spaced relation to the first fuel conduit 362a to define the annular fuel passage 371 for conveying one of the fuels. Each of the fuel conduits 362a and 362b includes one or more dampers 380a and 380b along the length thereof, and each damper 380a, 380b may be the same as or substantially similar to the above-described damper 80 and/or 280, and may be configured on the fuel conduits 362a, 362b in the same manner(s) as described above. In this manner, the first damper 380a and the second wire mesh damper 380b are each configured to support and damp vibrations of the first and second fuel conduits 362a, 362b by occupying the void space around the conduits. In the illustrated embodiment, the first damper 380a has a larger diameter than the second damper 380b to accommodate for the larger diameter of the first fuel conduit 362a. The dampers 380a and 380b may be provided in axial alignment with each other, as shown, or they could be provided in an axially offset configuration.

As shown, the second damper 380b is disposed within in the annular fuel passage 371, and therefore may be configured to allow the fuel (F) to pass through one or more holes provided in the damper 380b. In exemplary embodiments, the damper 380b is a wire mesh damper (as shown in FIGS. 4A-4C), which allows the fuel to flow through the gaps between the interwoven wires. The wire mesh damper 380b may be specifically configured to allow the fuel to freely flow with minimal restriction. The first wire mesh damper 380a also may be a wire mesh damper. The first wire mesh damper 380a may allow hot gas to escape from the internal pocket, which may enable a more uniform distribution of temperature along the length of the fuel conduit.

A damper for a fuel injector assembly of a gas turbine has been described herein. The damper is configured to damp vibration of one or more fuel conduits in the assembly. One or more dampers may at least partially surround the one or more fuel conduits. The damper(s) have an intermediate portion that is bowed relative to axial end portions to form a pocket, which enables the damper to be free to flex radially for damping the vibration experienced by the fuel conduit during operation of the gas turbine. The damper may be a wire mesh damper formed with interwoven wires that are configured to move relative to each other in response to vibrational movement of the fuel conduit. The wire mesh damper also may enable fluids, such as gases or fuel, to flow through gaps provided in the wire mesh. The damper may surround and support individual fuel conduits, thereby enabling the fuel conduits to thermally expand independently of each other in the assembly, which may reduce stress.

According to one aspect of the present disclosure, a gas turbine fuel injector assembly includes: a stem housing having one end configured for mounting in a gas turbine engine, and an opposite end for supporting a nozzle; at least one fuel conduit extending through the stem housing for directing fuel to the nozzle; and at least one wire mesh damper configured to at least partially surround the at least one fuel conduit within the stem housing, the at least one wire mesh damper having opposite axial end portions and an intermediate portion between the axial end portions; wherein the intermediate portion is bowed relative to the axial end portions to form a pocket intermediate the axial end portions, the bowed intermediate portion enabling the wire mesh damper to be free to flex radially in response to movement of the at least one fuel conduit for damping vibration of the at least one fuel conduit.

Embodiments may include one or more of the following additional features alone or in combination.

For example, the intermediate portion may be bowed radially outwardly with respect to the axial end portions to form the pocket at a radially interior portion of the at least one wire mesh damper.

The intermediate portion may be bowed radially outwardly with respect to the axial end portions to form a bulge at a radially exterior portion of the at least one wire mesh damper.

The pocket may be defined by a radially inner intermediate surface of the intermediate portion that is between respective radially inner end surfaces of the axial end portions.

The radially inner intermediate surface and the radially inner end surfaces may surround the at least one fuel conduit about a longitudinal axis thereof.

The radially inner intermediate surface forming the pocket is spaced apart from the at least one fuel conduit, and the radially inner end surfaces may be configured to engage the at least one fuel conduit.

The bulge may be defined by a radially outer intermediate surface of the intermediate portion that is opposite a radially inner intermediate surface which forms the pocket, the radially outer intermediate surface may be between respective radially outer end surfaces of the axial end portions.

The radially outer intermediate surface and the radially outer end surfaces may surround the at least one fuel conduit about a longitudinal axis thereof.

The radially outer intermediate surface forming the bulge may be configured to engage an adjacent fuel conduit and/or an inner surface of the stem housing.

The radially outer end surfaces may be spaced apart from the adjacent fuel conduit and/or the inner surface of the stem housing.

The at least one wire mesh damper may be configured as a wire mesh sleeve formed from interwoven wires.

The interwoven wires may cross over each other to define respective included angles therebetween.

The respective included angles between the wires that form the radially outwardly bowed intermediate portion may be fewer degrees than the respective included angles between the wires that form the axial end portions.

The interwoven wires forming the intermediate portion may be configured to move relative to each other to vary the included therebetween in response to movement of the at least one fuel conduit, which may enable the intermediate portion to freely flex radially for damping vibration of the at least one fuel conduit.

The wires may be interwoven to cross over each other in a diamond-shaped pattern.

The wires of the damper may be made from steel, stainless steel, nickel-based alloys, or similar high-temperature metals.

The wire mesh damper may have a wire density of between about 40×40 wires per inch to about 100×100 wires per inch, more particularly 60×60 wires per inch.

The wire diameter may be between about 0.005 inches to about 0.050 inches.

At least one of the axial end portions may be fixed to the at least one fuel conduit along a length thereof, such as by brazing, welding, or other suitable means.

The wire mesh damper may have only a single radial pocket at the intermediate portion between the axial end portions.

The wire mesh damper may have a substantially uniform wall thickness formed by the wire mesh.

The at least one fuel conduit may be a cylindrical tube extending along a longitudinal axis.

The wire mesh damper may have a tubular body that extends along the longitudinal axis to surrounds the at least one fuel conduit.

The pocket may be formed radially at an inner diameter surface of the intermediate portion of the tubular body.

The bulge may be formed radially at an outer diameter surface of the intermediate portion of the tubular body that is opposite the pocket.

The at least one fuel conduit may be a first fuel conduit, and the at least one wire mesh damper may be a first wire mesh damper. The stem housing may have a second fuel conduit adjacently spaced apart from the first fuel conduit within the stem housing. The second fuel conduit may have a second wire mesh damper that is configured substantially similar to the first wire mesh damper.

The first wire mesh damper and the second wire mesh damper may be fixed to the respective first and second fuel conduits in a longitudinally offset arrangement, such that a first portion of an outer surface forming the bulge of the first wire mesh damper engages a first portion of an inner surface of the stem housing, and a second portion of the outer surface of the first wire mesh damper engages an outer portion of the adjacent second fuel conduit, and such that a first portion of an outer surface forming the bulge of the second wire mesh damper engages an outer portion of the adjacent first fuel conduit, and a second portion of the outer surface of the second wire mesh damper engages a second portion of an inner surface of the stem housing.

The first wire mesh damper and the second wire mesh damper may each be configured to support and damp vibrations of the first and second fuel conduits by occupying the void space around each of the first and second fuel conduits in a radial direction across the stem housing.

The first fuel conduit and/or second fuel conduit may have a plurality of wire mesh dampers spaced along respective longitudinal lengths thereof.

The gas turbine fuel injector assembly may include the nozzle.

A gas turbine engine including the gas turbine fuel injector assembly according to any of the foregoing features.

A vehicle including the gas turbine engine according to any of the foregoing.

According to another aspect of the present disclosure, a damper for supporting and damping vibration of a tube in a gas turbine fuel injector assembly includes: a tubular body extending along a longitudinal axis, the tubular body having opposite axial end portions and an intermediate portion between the opposite end portions; wherein the intermediate portion is radially offset from the axial end portions to form a pocket intermediate the opposite axial end portions.

The tubular body may be formed from a wire mesh. The wire mesh may be formed by interwoven wires.

The intermediate portion of the tubular body may be offset radially outwardly to form the pocket at a radially interior portion of the tubular body.

The intermediate portion may be offset radially outwardly to form a bulge opposite the pocket.

According to another aspect of the present disclosure, a wire mesh damper for supporting and damping vibration of a tube in a gas turbine fuel injector assembly includes: a tubular body extending along a longitudinal axis, the tubular body having opposite axial end portions and a central portion between the opposite end portions; wherein the central portion of the tubular body has a radial inner diameter that is greater than a radial inner diameter of the respective end portions such that the radial inner diameter of the central portion forms an interior pocket between the opposite end portions of the tubular body.

According to another aspect of the present disclosure, a damper for supporting and damping vibration of a tube in a gas turbine fuel injector assembly includes: a body extending along a longitudinal axis, the body having a first portion and a longitudinally adjacent second portion; wherein the second portion is offset radially outwardly relative to the first portion to form a pocket radially inwardly of the second portion.

In some exemplary embodiments, the second portion has a radial inner diameter that is greater than a radial inner diameter of the first portion, the first portion having a radially inner surface configured to engage the tube in the fuel injector assembly, and the second portion having a radially outer surface configured to engage a wall spaced apart from the tube, wherein the first portion is a first axial end portion of the damper that forms a neck, and the second portion is a second axial end portion of the damper that forms a bulge, such that the pocket radially inwardly of the bulge opens in the longitudinal direction to the space between the tube and wall.

In some exemplary embodiments, the damper body further includes a third portion longitudinally adjacent to the first portion opposite the second portion, wherein the second and third portions are opposite axial end portions of the damper, respectively, and the first portion is an intermediate portion of the damper that is bowed radially inwardly relative to the axial end portions to form another pocket radially outwardly of the intermediate portion, the intermediate portion of the damper body has a radial inner diameter that is less than a radial inner diameter of the respective axial end portions.

In some exemplary embodiments, the damper body further includes a third portion longitudinally adjacent to the second portion opposite the first portion, wherein the first and second portions are opposite axial end portions of the damper, respectively, and the second portion is an intermediate portion of the damper that is offset radially outwardly relative to the axial end portions to form the pocket at a radially interior portion of the damper body, the intermediate portion of the damper body has a radial inner diameter that is greater than a radial inner diameter of the respective axial end portions.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A gas turbine fuel injector assembly, comprising:
a stem housing having one end configured for mounting in a gas turbine engine, and an opposite end for supporting a nozzle;
at least one fuel conduit extending through the stem housing for directing fuel to the nozzle; and
at least one wire mesh damper configured to at least partially surround the at least one fuel conduit within the stem housing, the at least one wire mesh damper having opposite axial end portions and an intermediate portion between the axial end portions;
wherein the intermediate portion is bowed relative to the axial end portions to form a pocket intermediate the axial end portions, the bowed intermediate portion enabling the wire mesh damper to be free to flex radially in response to movement of the at least one fuel conduit for damping vibration of the at least one fuel conduit.

2. The gas turbine fuel injector assembly according to claim 1, wherein the intermediate portion is bowed radially outwardly with respect to the axial end portions to form the pocket at a radially interior portion of the at least one wire mesh damper.

3. The gas turbine fuel injector assembly according to claim 1, wherein the intermediate portion is bowed radially outwardly with respect to the axial end portions to form a bulge at a radially exterior portion of the at least one wire mesh damper.

4. The gas turbine fuel injector assembly according to claim 1, wherein the pocket is defined by a radially inner intermediate surface of the intermediate portion that is between respective radially inner end surfaces of the axial end portions;
wherein the radially inner intermediate surface and the radially inner end surfaces surround the at least one fuel conduit about a longitudinal axis thereof; and
wherein the radially inner intermediate surface forming the pocket is spaced apart from the at least one fuel conduit, and the radially inner end surfaces are configured to engage the at least one fuel conduit.

5. The gas turbine fuel injector assembly according to claim 3, wherein the bulge is defined by a radially outer intermediate surface of the intermediate portion that is opposite a radially inner intermediate surface which forms the pocket, the radially outer intermediate surface being between respective radially outer end surfaces of the axial end portions;
wherein the radially outer intermediate surface and the radially outer end surfaces surround the at least one fuel conduit about a longitudinal axis thereof;
wherein the radially outer intermediate surface forming the bulge is configured to engage an adjacent fuel conduit and/or an inner surface of the stem housing; and
wherein the radially outer end surfaces are spaced apart from the adjacent fuel conduit and/or the inner surface of the stem housing.

6. The gas turbine fuel injector assembly according to claim 1, wherein the at least one wire mesh damper is configured as a wire mesh sleeve formed from interwoven wires.

7. The gas turbine fuel injector assembly according to claim 6, wherein the interwoven wires cross over each other to define respective included angles therebetween;
wherein the respective included angles between the wires that form the bowed intermediate portion are fewer degrees than the respective included angles between the wires that form the axial end portions; and
wherein the interwoven wires forming the intermediate portion are configured to move relative to each other to vary the included therebetween in response to movement of the at least one fuel conduit, which enables the intermediate portion to freely flex radially for damping vibration of the at least one fuel conduit.

8. The gas turbine fuel injector assembly according to claim 6, wherein the wires are interwoven to cross over each other in a diamond-shaped pattern.

9. The gas turbine fuel injector assembly according to claim 6, wherein the wires of the damper are made from steel, stainless steel, nickel-based alloys, or similar high-temperature metals.

10. The gas turbine fuel injector assembly according to claim 1, wherein at least one of the axial end portions is fixed to the at least one fuel conduit along a length thereof.

11. The gas turbine fuel injector assembly according to claim 1, wherein the wire mesh damper has only a single radial pocket at the intermediate portion between the axial end portions.

12. The gas turbine fuel injector assembly according to claim 1, wherein the at least one fuel conduit is a cylindrical tube extending along a longitudinal axis; and
wherein the wire mesh damper has a tubular body that extends along the longitudinal axis and surrounds the at least one fuel conduit.

13. The gas turbine fuel injector assembly according to claim 12, wherein the pocket is formed radially at an inner diameter surface of the intermediate portion of the tubular body; and
wherein the bulge is formed radially at an outer diameter surface of the intermediate portion of the tubular body that is opposite the pocket.

14. The gas turbine fuel injector assembly according to claim 1, wherein the at least one fuel conduit is a first fuel conduit, and the at least one wire mesh damper is a first wire mesh damper; and
wherein the stem housing has a second fuel conduit adjacently spaced apart from the first fuel conduit within the stem housing, the second fuel conduit having a second wire mesh damper that is configured substantially similar to the first wire mesh damper.

15. The gas turbine fuel injector assembly according to claim 14, wherein the first wire mesh damper and the second wire mesh damper are fixed to the respective first and second fuel conduits in a longitudinally offset arrangement, such that a first portion of an outer surface forming the bulge of the first wire mesh damper engages a first portion of an inner surface of the stem housing, and a second portion of the outer surface of the first wire mesh damper engages an outer portion of the adjacent second fuel conduit, and such that a first portion of an outer surface forming the bulge of the second wire mesh damper engages an outer portion of the adjacent first fuel conduit, and a second portion of the outer surface of the second wire mesh damper engages a second portion of an inner surface of the stem housing.

16. The gas turbine fuel injector assembly according to claim 14, wherein the first wire mesh damper and the second wire mesh damper are each configured to support and damp vibrations of the first and second fuel conduits by occupying the void space around each of the first and second fuel conduits in a radial direction across the stem housing.

17. A damper for supporting and damping vibration of a tube in a gas turbine fuel injector assembly, the damper comprising:
a body extending along a longitudinal axis, the body having a first portion and a longitudinally adjacent second portion;
wherein the second portion is offset radially outwardly relative to the first portion to form a pocket radially inwardly of the second portion.

18. The damper according to claim 17,
wherein the second portion has a radial inner diameter that is greater than a radial inner diameter of the first portion, the first portion having a radially inner surface configured to engage the tube in the fuel injector assembly, and the second portion having a radially outer surface configured to engage a wall spaced apart from the tube,
wherein the first portion is a first axial end portion of the damper body that forms a neck, and the second portion is a second axial end portion of the damper body that forms a bulge, such that the pocket radially inwardly of the bulge opens in the longitudinal direction to the space between the tube and wall.

19. The damper according to claim 17, further comprising a third portion longitudinally adjacent to the first portion opposite the second portion,
wherein the second and third portions are opposite axial end portions of the damper body, respectively, and the first portion is an intermediate portion of the damper body that is bowed radially inwardly relative to the axial end portions, the intermediate portion of the damper body having a radial inner diameter that is less than a radial inner diameter of the respective axial end portions to form another pocket radially outwardly of the intermediate portion.

20. The damper according to claim 17, further comprising a third portion longitudinally adjacent to the second portion opposite the first portion,
wherein the first and second portions are opposite axial end portions of the damper body, respectively, and the second portion is an intermediate portion of the damper body that is offset radially outwardly relative to the axial end portions, the intermediate portion of the damper body having a radial inner diameter that is greater than a radial inner diameter of the respective axial end portions to form the pocket at a radially interior portion of the damper body.
